(19) United States
(12) Patent Application Publication
(10) Pub. No.: US 2023/0130627 A1
(43) Pub. Date: Apr. 27, 2023

(54) METHOD FOR COLLABORATION USING CELL-BASED COMPUTATIONAL NOTEBOOKS

(71) Applicant: YANDEX EUROPE AG, Luzern (CH)

(72) Inventors: Artem Vladimirovich TROFIMOV, Kazan (RU); Vsevolod Andreevich STEPANOV, Sankt-Peterburg (RU); Igor Evgenevich KURALENOK, Sankt-Peterburg (RU)

(21) Appl. No.: 17/735,259

(22) Filed: May 3, 2022

(30) Foreign Application Priority Data
Oct. 21, 2021 (RU) 2021130747

(51) Int. Cl. G06F 8/36

(52) U.S. Cl. CPC G06F 8/36

(57) ABSTRACT

A method for collaboration using a cell-based computational notebook is described. The method includes receiving a cell on a first computer from the cell-based computational notebook, the cell including executable code, the executable code including variables. The method further includes executing the executable code in the cell to generate a result and saving in a storage medium a state of the cell, the state of the cell including values of the variables associated with the executable code in the cell and the result. A system implementing the method is also disclosed.

### CROSS-REFERENCE

The present application claims priority to Russian Patent Application No. 2021130744, entitled “Method for Collaboration Using Cell-Based Computational Notebooks,” filed on Oct. 21, 2021, the entirety of which is incorporated herein by reference.

### FIELD OF TECHNOLOGY

The present technology relates to computer-implemented interactive software development environments, and more specifically, to methods and systems for using cell-based computational notebooks for collaboration between users and deployment of microservices.

### BACKGROUND

With the growth of fields such as data science and artificial intelligence, computational notebooks have become a popular tool for interactively developing models and working with data. Computational notebooks provide for combining text, executable code, and the results of executing the code all in a single dynamic document. Current computational notebook systems include the JUPYTER interactive computing system, MATHEMATICA notebooks, and AZURE DATABRICKS notebooks.

In most current systems a computational notebook is made up of “cells,” which are blocks of content within the notebook that may contain formatted text, executable code, or other types of content. The cells that contain executable code (referred to as “code cells”) may be executed to produce output, which may include text, images, data visualizations, video, interactive “widgets,” audio, or any other type of content that may be output by a computer. Although code cells usually include relatively small blocks of code, they are not typically independent from other code blocks in a notebook. For example, a code block may include variables that are defined in a prior code block, and that are output as a graph in a later code block.

This interdependence of code blocks within a notebook means that the code blocks must be executed in a particular order, and generally cannot be easily separated from the notebook in which they were originally written. This makes it difficult to share or reuse code cells in computational notebooks and limits the ability to use notebooks collaboratively.

### SUMMARY

Various implementations of the disclosed technology store a state for code cells in cell-based computational notebooks. The state includes the values of variables associated with the code cell, as well as the results of executing the code cell. In some implementations, the state may also include files accessed in the code cell, all functions called in the code cell, and values of variables used in those functions. In general, the state of the cell may include anything in the runtime state of the kernel when a code cell is executed, such that the code cell can be restored at a later time or on a different computer, or even outside of the notebook in which it was originally written, with its state preserved.

Implementations of the disclosed technology also may assign unique addresses to cells that include a saved state (referred to herein as “collaborative cells”), which facilitate sharing the collaborative cells with other users and accessing the collaborative cells over a network or from other notebooks. Because the collaborative cells include the state information to permit them to be executed outside of the context of the notebook in which they were originally developed, they may be executed separately as “microservices” having an application programming interface (API) for sending inputs and receiving outputs from the collaborative cells. The disclosed technology therefore improves the ability of cell-based computational notebooks to be used collaboratively and enhances the process of developing software using computational notebooks.

In accordance with one aspect of the present disclosure, the technology is implemented in a method for collaboration using a cell-based computational notebook. The method includes receiving a cell on a first computer from the cell-based computational notebook, the cell including executable code, the executable code including variables. The method further includes executing the executable code in the cell to generate a result and saving in a storage medium a state of the cell, the state of the cell including values of the variables associated with the executable code in the cell and the result.

In some implementations, the state of the cell further includes files accessed in the cell. In some implementations, the files accessed in the cell are represented by portions of files accessed in the cell and by changes to the files resulting from executing the executable code in the cell. In some implementations, the executable code in the cell includes a call to a function and the state of the cell includes code for the function and values of variables associated with the function.

In some implementations, the storage medium includes network-accessible storage. In some implementations, the method further includes reading the state of the cell from the storage medium on a second computer to reproduce the cell, including its state, on the second computer.

In some implementations, the method further includes generating a unique address for the cell, including its state. In some implementations, the unique address for the cell is based, at least in part, on a name of the cell and on a name of a user of the cell. In some implementations, the method further includes using the unique address as a link to the cell, such that the cell and its state are accessed by following the link. In some implementations, the method further includes receiving an input from a first user indicating that the cell is to be shared with a second user, and sending an invitation to share the cell to the second user, the invitation including the unique address.

In some implementations, the state of the cell further includes an input to the cell and an output of the cell. In some of these implementations, the input to the cell is selected from the variables associated with the cell and the output of the cell is selected from the variables associated with the cell.

In some implementations, the method further includes generating a microservice based on the cell by exposing the input of the cell and the output of the cell to users of the microservice. In some implementations, exposing the input of the cell and the output of the cell includes generating an application programming interface providing access to the input of the cell and the output of the cell. In some implementations, the application programming interface includes a remote application programming interface. In some implementations, the application programming interface includes a web-based application programming interface.

In some implementations, the method further includes launching the microservice on a computer. In some implementations, the method further includes launching a plurality of instances of the microservice such that at least some instances of the microservice in the plurality of instances of the microservice execute simultaneously. In some implementations, launching the plurality of instances of the microservice includes launching the plurality of instances of the microservice on a plurality of computers. In some implementations, launching the plurality of instances of the microservice includes launching the plurality of instances of the microservice based on demand for use of the microservice.

In accordance with another aspect of the present disclosure, the technology is implemented in a system that includes a processor, a network interface coupled to the processor and communicatively coupled to a network, a storage medium, and a memory coupled to the processor. The system includes a server residing in the memory and executed by the processor, the server operating on a cell-based computational notebook stored on the storage medium. The server includes instructions that, when executed by the processor, cause the processor to: receive a cell from the cell-based computational notebook, the cell including executable code, the executable code including variables; execute the executable code in the cell to generate a result; and save in the storage medium a state of the cell, the state of the cell including values of the variables associated with the executable code in the cell and the result.

In some implementations, the storage medium is communicatively coupled to the network and the processor accesses the storage medium via the network interface.

In some implementations, the state of the cell further includes at least portions of files accessed in the cell. In some implementations, the executable code in the cell includes a call to a function and the state of the cell includes code for the function and values of variables associated with the function.

In some implementations, the server further includes instructions that, when executed by the processor, cause the processor to generate a unique address for the cell, including its state. In some implementations, the server further includes instructions that, when executed by the processor, cause the processor to send an invitation to share the cell via the network interface, the invitation including the unique address.

In some implementations, the server further includes instructions that, when executed by the processor, cause the processor to generate a microservice based on the cell by exposing an input of the cell and an output of the cell to users of the microservice. In some implementations, the server further includes instructions that, when executed by the processor, cause the processor to expose the input of the cell and the output of the cell by generating an application programming interface providing access to the input of the cell and the output of the cell. In some implementations, the application programming interface includes a remote application programming interface. In some implementations, the server further includes instructions that, when executed by the processor, cause the processor to launch the microservice on a computer.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for use in some implementations of systems and/or methods of the present technology.

FIG. 2 shows an example of an interface for an interactive cell-based computational notebook.

FIG. 3 shows an example high-level architecture of a cell-based computational notebook system.

FIG. 4 shows a block diagram of a cell-based computational notebook system in accordance with an implementation of the disclosed technology.

FIG. 5 is a block diagram of a method for storing and sharing a collaborative cell, in accordance with various implementations of the disclosed technology.

FIG. 6 is a block diagram for a method for receiving and restoring the state of a collaborative cell in accordance with various implementations of the disclosed technology.

FIG. 7 shows an example of a notebook that includes a code cell that may be used as the basis for a microservice for generating a random integer in an input range.

FIG. 8 is a block diagram of a method for launching cell-based microservices in accordance with various implementations of the disclosed technology

### DETAILED DESCRIPTION

Various representative implementations of the disclosed technology will be described more fully hereinafter with reference to the accompanying drawings. The present technology may, however, be implemented in many different forms and should not be construed as limited to the representative implementations set forth herein. In the drawings, the sizes and relative sizes of layers and regions may be exaggerated for clarity. Like numerals refer to like elements throughout.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The functions of the various elements shown in the figures, including any functional block labeled as a “processor,” may be provided through the use of dedicated hardware as well as hardware capable of executing software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, an application-specific integrated circuit (ASIC), a field-programmable gate array (FPGA), a read-only memory (ROM) for storing software, a random-access memory (RAM), and non-volatile storage. Other hardware, conventional and/or custom, may also be included.

Software modules, or simply modules or units which are implied to be software, may be represented herein as any combination of flowchart elements or other elements indicating the performance of process steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

The present technology may be implemented as a system, a method, and/or a computer program product. The computer program product may include a computer-readable storage medium (or media) storing computer-readable program instructions that, when executed by a processor, cause the processor to carry out aspects of the disclosed technology. The computer-readable storage medium may be, for example, an electronic storage device, a magnetic storage device, an optical storage device, an electromagnetic storage device, a semiconductor storage device, or any suitable combination of these. A non-exhaustive list of more specific examples of the computer-readable storage medium includes: a portable computer disk, a hard disk, a random-access memory (RAM), a read-only memory (ROM), a flash memory, an optical disk, a memory stick, a floppy disk, a mechanically or visually encoded medium (e.g., a punch card or bar code), and/or any combination of these. A computer-readable storage medium, as used herein, is to be construed as being a non-transitory computer-readable medium. It is not to be construed as being a transitory signal, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that computer-readable program instructions can be downloaded to respective computing or processing devices from a computer-readable storage medium or to an external computer or external storage device via a network, for example, the Internet, a local area network, a wide area network and/or a wireless network. A network interface in a computing/processing device may receive computer-readable program instructions via the network and forward the computer-readable program instructions for storage in a computer-readable storage medium within the respective computing or processing device.

Computer-readable program instructions for carrying out operations of the present disclosure may be assembler instructions, machine instructions, firmware instructions, configuration data for integrated circuitry, or either source code or object code written in any combination of one or more programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network.

All statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable program instructions. These computer-readable program instructions may be provided to a processor or other programmable data processing apparatus to generate a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowcharts, flow diagrams, state transition diagrams, pseudo-code, and the like.

The computer-readable program instructions may also be loaded onto a computer, other programmable data processing apparatus or other devices to cause a series of operational steps to be performed on the computer, other programmable apparatus or other devices to generate a computer-implemented process, such that the instructions which execute on the computer, other programmable apparatus, or other device implement the functions/acts specified in the flowcharts, flow diagrams, state transition diagrams, pseudo-code, and the like.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures, and combinations of such functions can be implemented by special-purpose hardware-based systems that perform the specified functions or acts or by combinations of special-purpose hardware and computer instructions.

With these fundamentals in place, we will now consider some non-limiting examples to illustrate various implementations of aspects of the present disclosure.

### Computer System

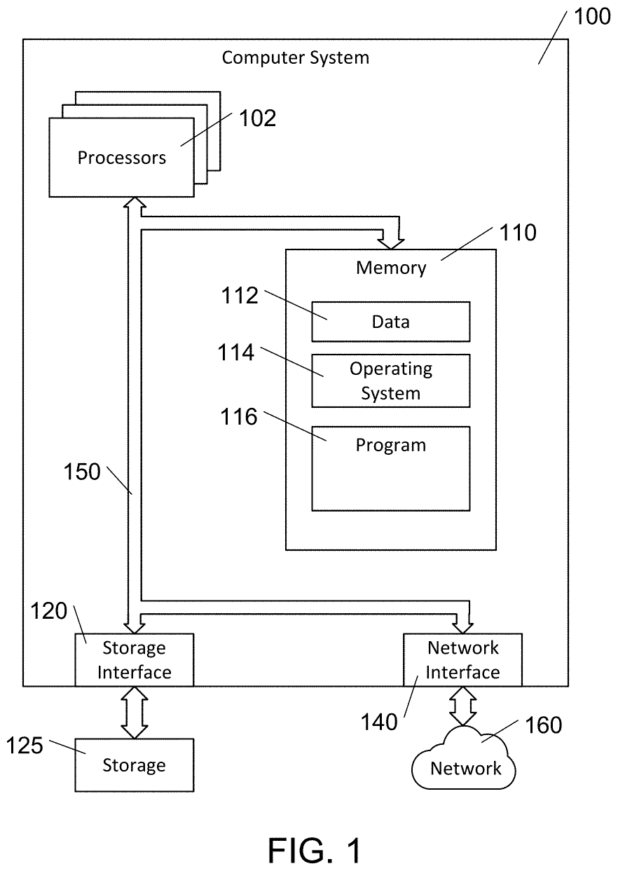

FIG. 1 shows a computer system 100. The computer system 100 may be a multi-user computer, a single user computer, a laptop computer, a tablet computer, a smartphone, an embedded control system, or any other computer system currently known or later developed. Additionally, it will be recognized that some or all the components of the computer system 100 may be virtualized and/or cloud-based. As shown in FIG. 1, the computer system 100 includes one or more processors 102, a memory 110, a storage interface 120, and a network interface 140. These system components are interconnected via a bus 150, which may include one or more internal and/or external buses (not shown) (e.g. a PCI bus, universal serial bus, IEEE 1394 “Firewire” bus, SCSI bus, Serial-ATA bus, etc.), to which the various hardware components are electronically coupled.

The memory 110, which may be a random-access memory or any other type of memory, may contain data 112, an operating system 114, and a program 116. The data 112 may be any data that serves as input to or output from any program in the computer system 100. The operating system 114 is an operating system such as MICROSOFT WINDOWS or LINUX. The program 116 may be any program or set of programs that include programmed instructions that may be executed by the processor to control actions taken by the computer system 100.

The storage interface 120 is used to connect storage devices, such as the storage device 125, to the computer system 100. One type of storage device 125 is a solid-state drive, which may use an integrated circuit assembly to store data persistently. A different kind of storage device 125 is a hard drive, such as an electro-mechanical device that uses magnetic storage to store and retrieve digital data. Similarly, the storage device 125 may be an optical drive, a card reader that receives a removable memory card, such as an SD card, or a flash memory device that may be connected to the computer system 100 through, e.g., a universal serial bus (USB).

In some implementations, the computer system 100 may use well-known virtual memory techniques that allow the programs of the computer system 100 to behave as if they have access to a large, contiguous address space instead of access to multiple, smaller storage spaces, such as the memory 110 and the storage device 125. Therefore, while the data 112, the operating system 114, and the programs 116 are shown to reside in the memory 110, those skilled in the art will recognize that these items are not necessarily wholly contained in the memory 110 at the same time.

The processors 102 may include one or more microprocessors and/or other integrated circuits. The processors 102 execute program instructions stored in the memory 110. When the computer system 100 starts up, the processors 102 may initially execute a boot routine and/or the program instructions that make up the operating system 114.

The network interface 140 is used to connect the computer system 100 to other computer systems or networked devices (not shown) via a network 160. The network interface 140 may include a combination of hardware and software that allows communicating on the network 160. In some implementations, the network interface 140 may be a wireless network interface. The software in the network interface 140 may include software that uses one or more network protocols to communicate over the network 160. For example, the network protocols may include TCP/IP (Transmission Control Protocol/Internet Protocol).

It will be understood that the computer system 100 is merely an example and that the disclosed technology may be used with computer systems or other computing devices having different configurations.

### Computational Notebooks

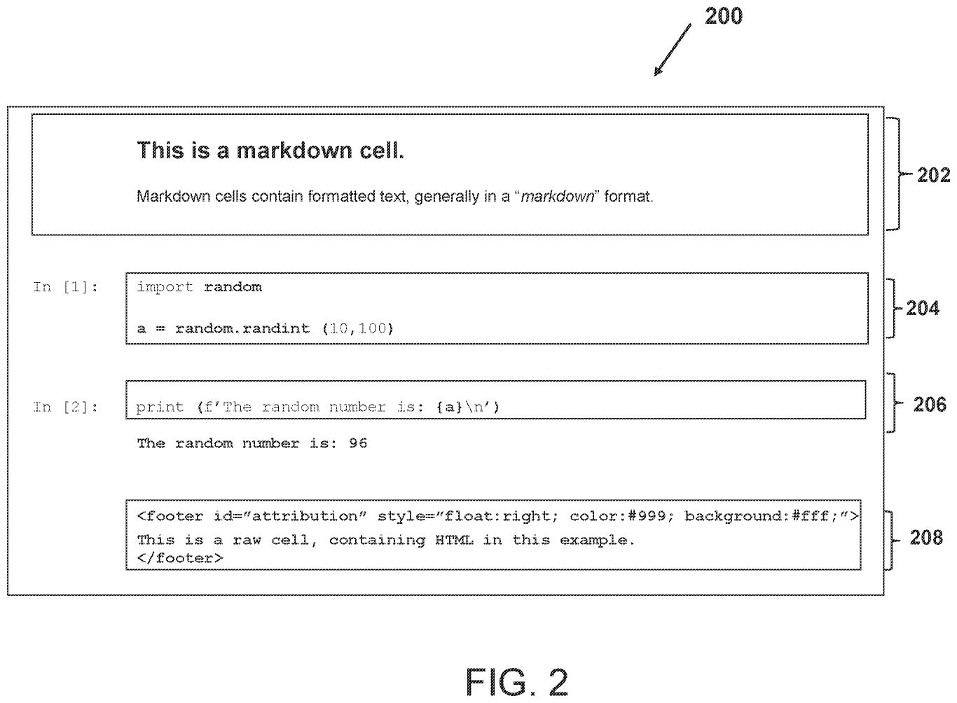

FIG. 2 shows an example of an interface for an interactive cell-based computational notebook 200. The cell-based computational notebook 200 is a structure or file that is made up of “cells,” such as cells 202, 204, 206, and 208. In the example shown in FIG. 2, each cell may be one of several types of cell, such as a “markdown” cell, a “code” cell, or a “raw” cell. A markdown cell, such as cell 202, contains formatted text that (in this example) is expressed in a markdown format (not shown). A code cell, such as cells 204 and 206, contains source code that may be executed by a kernel (see below) to change the runtime state of the kernel and/or to produce output, such as code cell output 210, associated with code cell 206. The output of a code cell may be text, graphics, sound, video, animation, interactive widgets, or any other kind of output that may be produced by a computer. A raw cell, such as cell 208, generally includes content that is not evaluated by the kernel associated with the notebook. A raw cell may contain, for example, commands to be used by notebook conversion software, that may convert a notebook file into a format that may be easily published, such as PDF, HTML, or LaTeX.

Because the code cells can alter the runtime state of the kernel that executes the code in the cell-based computational notebook 200, in a conventional notebook system, the code cells need to be executed in order. For example, if the code cell 206 is executed prior to the code cell 204, the variable “a” will not have been defined, resulting in an error. Thus, the cells in a conventional notebook system do not stand on their own, but only work as a part of the notebook, and must be executed in a particular order to properly produce their results.

It will be understood that the cell types described above are the cell types that are used in notebooks in the JUPYTER interactive computing system. There are other cell-based notebook systems, such as MATHEMATICA notebooks, which may support different types of cells. The person of ordinary skill in the art will recognize that the technology described herein, while described with reference to notebooks in the JUPYTER interactive computing system, could be applied to other cell-based computational notebook systems. Additionally, the code in the code cells 204 and 206 is written in the PYTHON programming language. It will be understood that most any programming language could be used in a notebook, and PYTHON is being used only for purposes of illustration.

In the example shown in FIG. 2, the cell-based computational notebook 200 provides an interactive “document” that may include executable code (generally as source code) in code cells. Such notebooks are increasingly being used in data science and artificial intelligence applications. They provide users with an interactive environment in which their computations may be written, tested, edited, and documented, along with their results. A notebook, unlike other development environments, provides a self-contained record of a computation, with code and results. A user of the cell-based computational notebook 200 can add or delete cells, edit cells, and execute code cells, such as the code cells 204 and 206. The user can also share notebooks with other users and convert notebooks into a variety of static formats for publication or sharing.

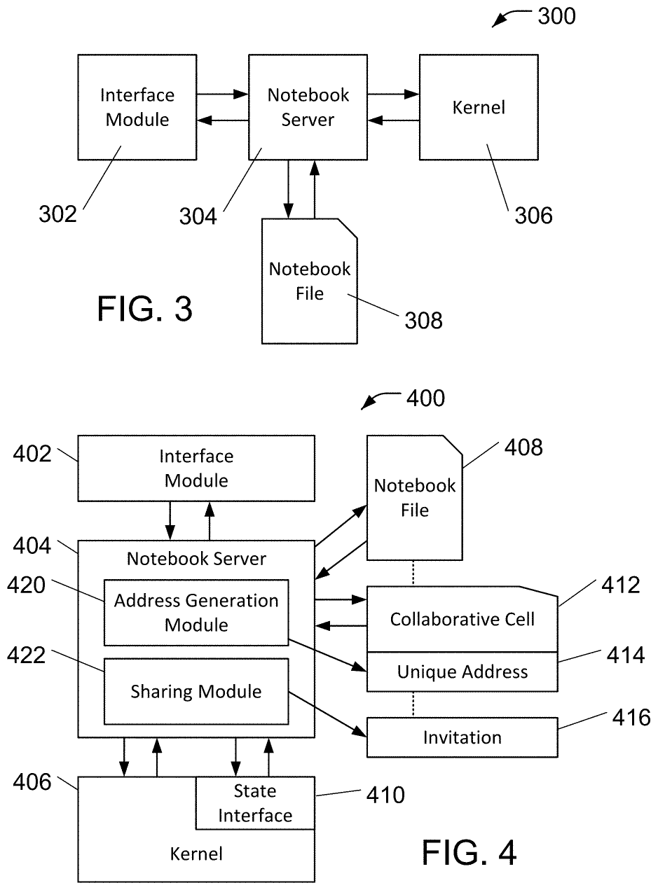

Referring now to FIG. 3, an example high-level architecture of a cell-based computational notebook system 300 is described. The cell-based computational notebook system 300 includes an interface module 302, a notebook server 304, and a kernel 306. These components may run on the same computer, or on different computers, connected via a network.

The interface module 302 handles interactions with the user of the cell-based computational notebook system 300. It displays the notebook and all cells to the user, and accepts input from the user. In some implementations, the interface module 302 may include a web browser, which communicates with the notebook server using standard protocols appropriate for a web browser, such as HTTP and/or the Web Sockets API. It should be noted that using a web browser and protocols appropriate for a web browser in the interface module is for illustrative purposes. In some implementations, the interface module 302 may be, for example, a custom user interface that communicates with a notebook server through a proprietary API. It will be understood by those of ordinary skill in the art that many user interface technologies and communication protocols may be used.

The notebook server 304 is responsible for loading and saving notebooks in, e.g., notebook files, such as the notebook file 308. The notebook server 304 also handles interactions with the interface module 302 to display the contents of a notebook and to receive input from the user of a notebook and communicates with the kernel 306 to execute code cells and receive results of execution. This communication with the kernel 306 may be handled using various communication protocols or APIs, depending on the environment in which the notebook server 304 and the kernel 306 are executing. For example, in some implementations, a protocol for providing control over the kernel may be used with a messaging library or protocol for use in distributed applications, such as ZeroMQ. The notebook server 304 may also handle conversion of a notebook into a static format (not shown), such as an HTML file, a LaTeX file, or a PDF file.

The kernel 306 is responsible for executing code that is sent to it by the notebook server 304 and sending output from executing the code back to the notebook server 304. Generally, the kernel 306 will handle code written in a particular programming language, such as PYTHON, R, JULIA, C++, etc. Executing the code may involve interpreting the code, or compiling the code using a conventional or “just-in-time” (JIT) compiler. The kernel 306 also keeps a runtime state of the executing code, which includes the values of all variables, the call stack, the file handles for all open files and/or network sockets, etc. The kernel 306 is typically isolated from the notebook—it is sent cells of code to execute by the notebook server 304 and sends output from execution back to the notebook server 304.

In a conventional notebook system, although the output of a code cell may be saved as a part of the notebook, the runtime state of the kernel is not saved. This means that if the notebook is loaded again later, after the system has been shut down, or if the notebook is loaded on a different computer, the saved output may be shown, but the runtime state of the kernel will be different, so the code would need to be re-executed to re-establish the runtime state before additional work may be done in the notebook. In some instances, even executing the code cells in order may not produce the same results. For example, referring again to FIG. 2, in the code cell 204, the variable “a” is a random integer between 10 and 100. Although the “randint” function produces only a pseudo-random result, unless the random number seed was the same, executing this code will not provide the same result. Similar issues may occur whenever there is user input that may vary between two executions, input from files that may have changed, input from an external source such as a sensor or network, and so on.

Thus, a notebook that is shared with another user may not produce the same results on that user's computer. Even when reloading a notebook, a user may need to re-execute the code cells, and even so might not obtain the same results. Further, because cells may rely on a runtime state that has been established by other cells in the notebook, it may not be possible to extract a cell from a notebook, to reuse or share only the code in that cell.

The present technology addresses these issues, at least in part, by storing a state for code cells. The state includes the values of variables associated with the code cell, as well as the results of executing the code cell. In some implementations, the state may also include files accessed in the code cell, all functions called in the code cell, and values of variables used in those functions. In general, the state of the cell may include anything in the runtime state of the kernel 306 when a code cell is executed, such that the code cell can be restored at a later time or on a different computer, or even outside of the notebook in which it was originally written, with its state preserved.

FIG. 4 shows a high-level block diagram of a cell-based computational notebook system 400 in accordance with an implementation of the disclosed technology. As can be seen, the cell-based computational notebook system 400 is similar to the cell-based computational notebook system 300, described above with reference to FIG. 3. The cell-based computational notebook system 400 includes an interface module 402, a notebook server 404, and a kernel 406.

The interface module 402 handles interactions with the user of the cell-based computational notebook system 400. It displays the notebook and all cells to the user, and accepts input from the user. As with the cell-based computational notebook system 300, described with reference to FIG. 3, the interface module 402 may include a web browser, which communicates with the notebook server using standard protocols appropriate for a web browser, such as HTTP and/or the Web Sockets API.

The notebook server 404 loads and saves notebooks in, e.g., notebook files, such as the notebook file 408, handles interactions with the interface module 402 to display the contents of a notebook and to receive input from the user of a notebook, and may handle conversion of a notebook into a static format (not shown). The notebook server also communicates with the kernel 406 to execute code cells and receive results of execution. Additionally, in accordance with some implementations of the disclosed technology, the notebook server 404 may communicate with a state interface 410 of the kernel 406 to receive information on the runtime state of the kernel 406. All or part of this state information may then be saved by the notebook server 404, along with a code cell, as a collaborative cell 412. The state information stored in the collaborative cell 412 may include the values of variables associated with the code cell, the results of executing the code cell, files accessed in the code cell, functions called in the code cell, values of variables used in those functions, and other information on the state of the cell, its inputs, and its outputs. In some implementations, the collaborative cell 412 may be saved on a network-accessible storage medium (not shown). In some implementations, other computers on the network (not shown) may access the collaborative cell 412, to reproduce the cell, including its state.

It will be understood that storing the state information for the collaborative cell 412 may be resource intensive. For example, if files that are accessed in a cell are stored as part of the state of the cell, the files may use large amounts of storage. In some cases, a cell may access databases that are many gigabytes or terabytes in size. To reduce the amount of storage used, known techniques, such as storing only the portions of files or databases that are accessed or changed in the cell, or storing file differences that result from execution of the cell may be used in some implementations.

In some implementations, the notebook server 404 may include an address generation module 420. The address generation module 420 generates a unique address 414 for the collaborative cell 412. This unique address 414 may, for example, be determined using the name of the user who developed the collaborative cell 412, the name of the notebook from which it originated, a name assigned to the cell, time and date information, information from the state of the collaborative cell 412, such as a hash of the state information, a random identifier, or other information that is known to be used in the generation of unique addresses or file names. The unique address 414 prepared by the address generation module 420 may be associated with the collaborative cell 412, and, in some implementations, may be used as a link to the collaborative cell 412, to provide access to the collaborative cell 412.

In some implementations, the notebook server 404 may include a sharing module 422. The sharing module 422 controls the sharing of the collaborative cell 412. In some implementations, the user of the notebook may specify that a cell is to be shared with another user. The sharing module 422 may then send an invitation 416 to this other user, via email or other electronic communications, to share the collaborative cell 412. In some implementations, the invitation 416 may include the unique address 414 of the collaborative cell 412.

As will be described below, in some implementations, the notebook server 404 may also facilitate the use of a collaborative cell, such as the collaborative cell 412 as a microservice. Because the collaborative cells include state information that permits them to be executed outside of the context of a notebook, they can provide services by accepting inputs to collaborative cell through an interface to the cell and providing outputs over the interface.

The kernel 406 is responsible for executing code that is sent to it by the notebook server 404 and sending output from executing the code back to the notebook server 404. The kernel 406 also keeps a runtime state of the executing code, which includes the values of all variables, the call stack, the file handles for all open files and/or network sockets, etc. Because the kernel 406 is isolated from the notebook, a state interface 410 is used to provide access to runtime state information to the notebook server 404. In some implementations, the state interface 410 may use a known protocol, such as the Debug Adaptor Protocol (DAP) to provide access to state information, such as the values of variables. In some implementations, the state interface 410 may use a proprietary protocol to provide access to state information. The state interface 410 may also provide state information to the notebook server 404 in a serialized form, e.g., as a serialized stream in response to a request for state information.

It will be understood that the block diagram shown in FIG. 4 is only one example of a cell-based computational notebook system in accordance with the present technology, and that many other implementations are possible. For example, in some implementations, the state information for the collaborative cell could be saved directly by the kernel 406, rather than by the notebook server 404. Such implementations may not use an interface, such as the state interface 410, to permit access to the state information in the kernel 406. In some implementations, known libraries could be used in the kernel to serialize state information for a collaborative cell. For example, for a PYTHON kernel, the “DILL” library (as discussed, for example, in M. M. McKerns, L. Strand, T. Sullivan, A. Fang, M. A. G. Aivazis, “Building a framework for predictive science”, Proceedings of the 10th Python in Science Conference, 2011) may be used to serialize kernel runtime state information.

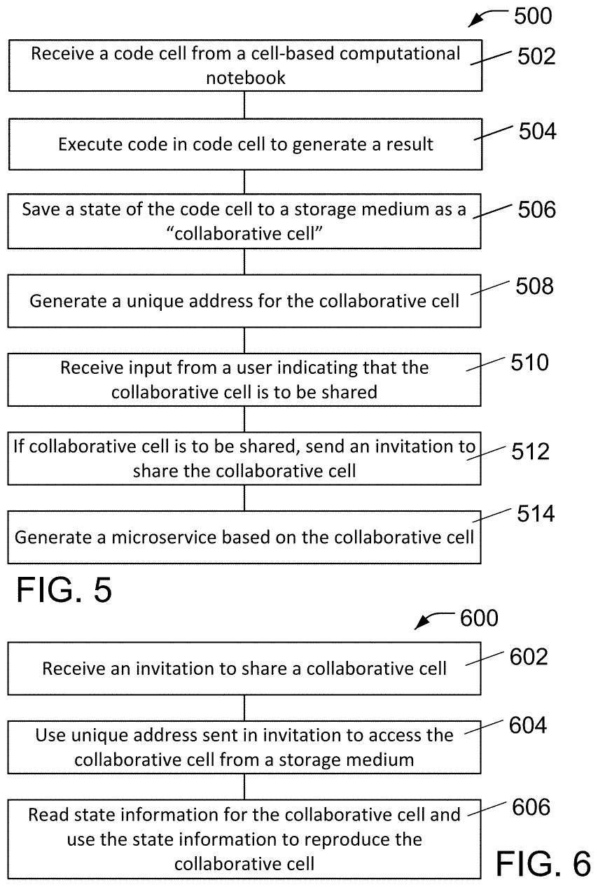

FIG. 5 shows a block diagram of a method 500 for storing and sharing a collaborative cell, in accordance with some implementations of the disclosed technology. In block 502, a code cell including executable code is received from a cell-based computational notebook. The executable code may include variables and may access files and/or functions. As used herein, executable code in a cell is source code written in a programming language that may be interpreted or compiled to be executed on a computer but may also be any code that may be directly executed on a computer or that may be converted into an executable form. Functions may include, for example, functions, subroutines, classes, modules, or other reusable blocks of code. Such functions may be used and/or defined within a code cell.

In block 504, the executable code in the cell is executed on a computer to generate a result. Execution of the executable code may involve interpreting or compiling the code. The result may be displayed to a user or otherwise output, or may involve only internal changes in the runtime state of the kernel on which the code is executed.

In block 506, the state of the cell is saved to a storage medium, such as a hard drive. The state of the cell may include the values of any variables associated with the cell, the results of executing the cell, any files accessed in the cell, any functions accessed and/or defined in the cell, and the variables or files accessed in those functions, and any other information on the runtime state of the cell that may be used to restore the state of the cell at a later time or on another computer. In some implementations, the storage medium may include network-accessible storage, and in some implementations, the state of the cell may be saved in a serialized form.

In block 508, a unique address for the collaborative cell is generated. As discussed above, the unique address may be determined using the name of the user who developed the collaborative cell, the name of the notebook from which it originated, a name assigned to the cell, time and date information, information from the state of the collaborative cell, such as a hash of the state information, a random identifier, or other information that is known to be used in the generation of unique addresses or file names. In some implementations, the unique address may be used as a link to the collaborative cell.

In block 510, input from a user of the cell-based computational notebook indicating that the collaborative cell is to be shared with another user. The other user may be on the same computer or on a different computer. Based on receiving this input, in block 512, an invitation to share the collaborative cell is sent to the other user. The invitation may include the unique address for the collaborative cell.

In some implementations, an additional block 514 may generate a microservice based on the collaborative cell. This may be done, for example, by designating variables that are used in the collaborative cell as inputs and outputs of the collaborative cell, and by exposing these inputs and outputs to users of the microservice. Cell-based microservices will be discussed in greater detail below.

FIG. 6 shows a block diagram for a method 600 for receiving and restoring the state of a collaborative cell in accordance with some implementations of the disclosed technology. In block 602, an invitation to share a collaborative cell is received on a computer. The invitation includes a unique address for the collaborative cell.

In block 604, the unique address is used to access the collaborative cell. In some implementations, the unique address includes a link to the collaborative cell that is used to access the collaborative cell from a storage medium. In some implementations, the unique address is used to access the collaborative cell from network-accessible storage. In some implementations, accessing the collaborative cell involves sending the unique address to a server, such as a notebook server.

In block 606, the state information for the collaborative cell is read from a storage medium, and the collaborative cell, including its state, is reproduced. In some implementations, this may be done by reading serialized state information from a storage medium, and re-establishing the state in the kernel of a cell-based computational notebook system.

### Cell-Based Microservices

In addition to providing for collaboration and sharing of cells, the disclosed technology may be used to provide “microservices” based on cells and their state. A microservice is an independent piece of software that performs a defined task and that communicates through a defined API. In a microservices software architecture, applications can be constructed from a set of such microservices communicating with each other.

Code cells in notebooks are small units of code that are often built to perform a single function. Because the collaborative cells of the present technology permit notebook cells to be executed outside of the context of a notebook, collaborative cells may be used as microservices. With the unique addresses that may be provided to collaborative cells, users may link together cells written by each other in different orders and combinations to create new programs. To make collaborative cells more like microservices, which have a defined API, certain of the variables associated with a cell may be designated as inputs and/or outputs and may define the API to the cell as a microservice.

As an example of using a cell as a microservice, a machine learning engineer in a company may build a notebook in which a neural network is trained to recognize cats and dogs in images. One of the code cells in this notebook may be set up to determine whether an input image is a cat or a dog. The input to the cell would be an image, and the outputs may be the probability that the image shows a cat and the probability that the image shows a dog. The input and outputs to the cell may be variables that are accessed in the cell. For example, within the notebook, the cell's user may store the input image in a variable that is used in the cell, and may receive the output probabilities in variables that are set within the cell. By storing this cell along with its state as a collaborative cell, the cell can be used outside of the notebook, while keeping access to the state that was built up in the notebook, such as the neural network and its training.

Another user could use this collaborative cell, for example, to calculate the distribution of dog and cat photos posted by INSTAGRAM users. This could be done by sending the each of the photos to the cell (e.g., using the cell's unique address) as input, and collecting the outputs from the cell. These outputs could then be sent to another cell that is able to summarize the total number of cat and dog images. By exposing the input image variable and the output probability variables as an API, the cell that was set up for determining whether an input image is of a dog or a cat is transformed into a network-accessible microservice that may be used to perform its service on behalf of other programs and users.

This microservice could be handled on a single computer, such that the entire set of photos are processed by a single instance of the microservice launched on one computer. Alternatively, multiple instances of the microservice could be launched on several computers simultaneously, such that the photos are split between multiple computers and/or instances of the microservice. Processing the photos in parallel may permit the task to be completed faster. The number of instances of a cell-based microservice that are launched for simultaneous execution may depend, e.g., on the demand for use of the microservice.

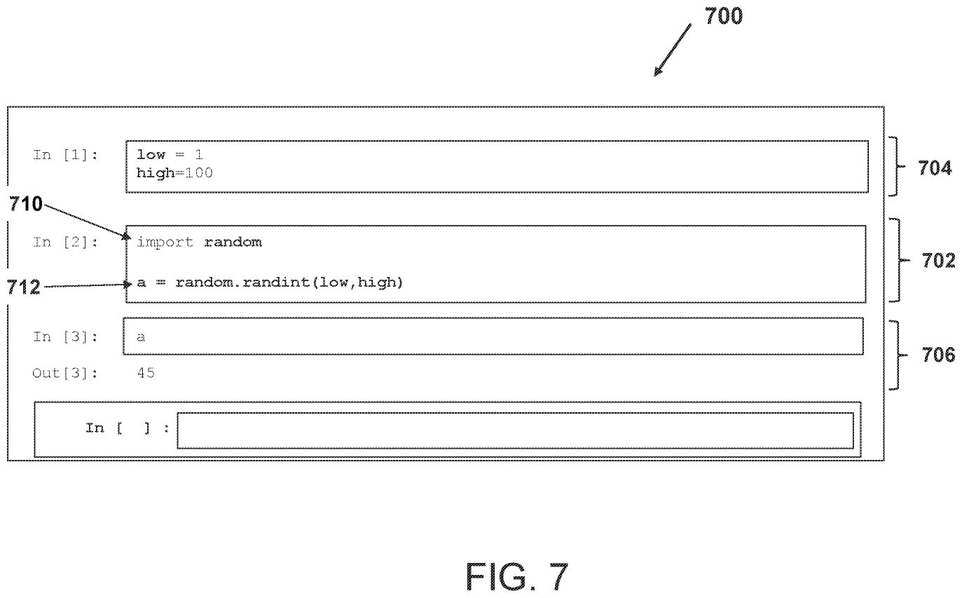

FIG. 7 shows an example of a notebook 700 that includes a code cell 702 that could be used as a microservice for generating a random integer in an input range. In line 710, the code cell 702 imports the “random” module, which is a module for generating random numbers. In line 712, the code cell 702 uses the “randint” function in the “random” module to generates a random integer between the value of the “low” variable and the value of the “high” variable, and stores the random integer in the variable “a”. The notebook 700 also includes a cell 704 that sets the value of “low” as 1 and the value of “high” as 100, and a cell 706, which causes the value of the variable “a” to be displayed (in the example shown in FIG. 7, “a” has a value of 45).

When the code cell 702 is saved with its state as a collaborative cell, the values of the variables “high”, “low”, and “a” will be stored, along with the code in the code cell 702, and the “random” module, with the “randint” function, and all of the variables, functions, and other state on which the “randint” function depends. To use this saved collaborative cell as a microservice, the variables “low” and “high” may be exposed as inputs in the microservice API, and the variable “a” may be exposed as an output from the microservice. With the API specified, the microservice may be used by in other programs through its API. In some implementations, the API may be a remote or web-based API (i.e., an API that is accessed using HTTP methods, such as GET or POST), permitting the collaborative cell to be used as a microservice over a network.

In some implementations, the API to the microservice may be explicitly specified by the user who makes the cell available as a microservice. In some implementations, the API may be generated automatically, by exposing the variables used in a cell, and permitting a user of the microservice to access and override values of variables that were stored as part of the state of a collaborative cell.

It will be understood by those of ordinary skill in the art that the commands to invoke a cell as a microservice may be handled by a server (not shown) that accepts the commands over a network, and that launches/executes an instance of the microservice based on the stored collaborative cell. The server may launch numerous instances of the microservice, at least some of which may execute simultaneously. In some implementations, instances of the microservice may be launched/executed on numerous computers. In some implementations, the number of instances of a microservice that are launched by the server to operate simultaneously may depend on the demand for the microservice.

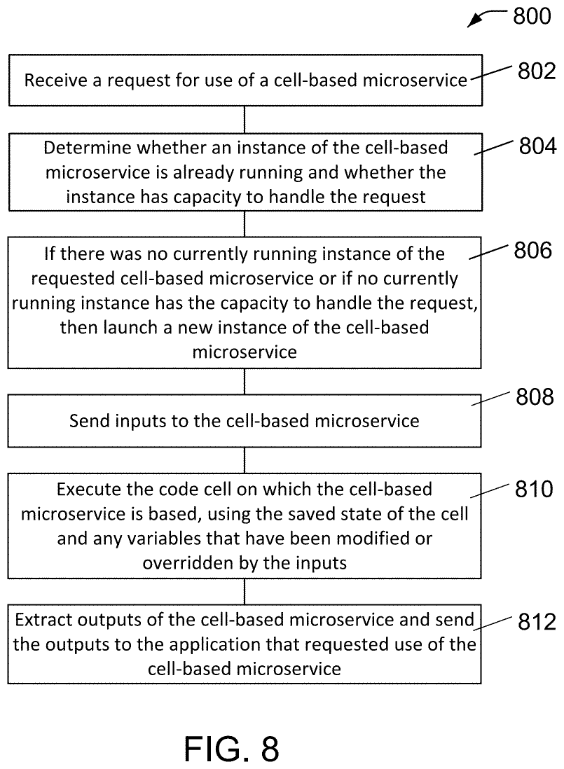

FIG. 8 shows a block diagram of a method 800 for launching cell-based microservices in accordance with some implementations of the disclosed technology. In block 802, a request for use of a cell-based microservice is received by a server (not shown). In some implementations, the request may include the unique address of the cell-based microservice. In some implementations, the request may include values for the inputs to the cell-based microservice.

In block 804, the server determines whether an instance of the cell-based microservice is already running, and whether that instance has capacity to handle the received request. In some implementations, this may involve checking the status of cell-based microservices running on numerous computers.

In block 806, if there was no currently running instance of the requested cell-based microservice, or if no currently running instance has the capacity to handle the received request, then the server launches a new instance of the cell-based microservice. In some implementations, this may be done by launching an execution kernel for the programming language in which the cell is written, and then loading the collaborative cell on which the cell-based microservice is based and its saved state. In some instances, the kernel and cell-based microservice may be launched in a container, such as a DOCKER container. In some implementations, the kernel and cell-based microservice may be launched on a computer other than the computer on which the server is executing. This may be done using a container orchestration platform, such as KUBERNETES, or other systems for application deployment and management. In some implementations, launching the cell-based microservice may also involve launching a notebook server to read and deploy the collaborative cell to an execution kernel.

In block 808, inputs to the cell-based microservice are sent to the cell-based microservice. In some implementations, this may be done by setting values of the variables that are used as inputs to the cell prior to executing the cell.

In block 810, the code cell on which the cell-based microservice is based is executed by the kernel. The state of the code cell will be the saved state, along with any variables that have been modified or overridden by the inputs to the cell-based microservice.

In block 812, the outputs of the cell-based microservice are extracted and returned to the application that requested use of the cell-based microservice. In some implementations, this may involve reading the values of variables that contain the outputs of the cell-based microservice.

It will also be understood that, although the embodiments presented herein have been described with reference to specific features and structures, various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A computer-implemented method for collaboration using a cell-based computational notebook, the method comprising:
receiving a cell on a first computer from the cell-based computational notebook, the cell comprising executable code, the executable code including variables;
executing the executable code in the cell to generate a result; and
saving in a storage medium a state of the cell, the state of the cell comprising values of the variables associated with the executable code in the cell and the result.

2. The computer-implemented method of claim 1, wherein the state of the cell further comprises files accessed in the cell.

3. The computer-implemented method of claim 2, wherein the files accessed in the cell are represented by portions of files accessed in the cell and by changes to the files resulting from executing the executable code in the cell.

4. The computer-implemented method of claim 1, wherein the storage medium comprises network-accessible storage.

5. The computer-implemented method of claim 1, wherein the executable code in the cell comprises a call to a function and wherein the state of the cell comprises code for the function and values of variables associated with the function.

6. The computer-implemented method of claim 1, further comprising reading the state of the cell from the storage medium on a second computer to reproduce the cell, including its state, on the second computer.

7. The computer-implemented method of claim 1, further comprising generating a unique address for the cell, including its state.

8. The computer-implemented method of claim 7, wherein the unique address for the cell is based, at least in part, on a name of the cell and on a name of a user of the cell.

9. The computer-implemented method of claim 7, further comprising using the unique address as a link to the cell, such that the cell and its state are accessed by following the link.

10. The computer-implemented method of claim 7, further comprising:
receiving an input from a first user indicating that the cell is to be shared with a second user; and
sending an invitation to share the cell to the second user, the invitation including the unique address.

11. The computer-implemented method of claim 1, wherein the state of the cell further comprises an input to the cell and an output of the cell.

12. The computer-implemented method of claim 11, wherein the input to the cell is selected from the variables associated with the cell and the output of the cell is selected from the variables associated with the cell.

13. The computer-implemented method of claim 11, further comprising generating a microservice based on the cell by exposing the input of the cell and the output of the cell to users of the microservice.

14. The computer-implemented method of claim 13, wherein exposing the input of the cell and the output of the cell comprises generating an application programming interface providing access to the input of the cell and the output of the cell.

15. The computer-implemented method of claim 13, further comprising launching the microservice on a computer.

16. The computer-implemented method of claim 13, further comprising launching a plurality of instances of the microservice such that at least some instances of the microservice in the plurality of instances of the microservice execute simultaneously.

17. The computer-implemented method of claim 16, wherein launching the plurality of instances of the microservice comprises launching the plurality of instances of the microservice on a plurality of computers.

18. The computer-implemented method of claim 16, wherein launching the plurality of instances of the microservice comprises launching the plurality of instances of the microservice based on demand for use of the microservice.

19. A system comprising:
a processor;
a network interface coupled to the processor and communicatively coupled to a network;
a storage medium;
a memory coupled to the processor; and
a server residing in the memory and executed by the processor, the server operating on a cell-based computational notebook stored on the storage medium, the server comprising instructions that, when executed by the processor, cause the processor to:
receive a cell from the cell-based computational notebook, the cell comprising executable code, the executable code including variables;
execute the executable code in the cell to generate a result; and
save in the storage medium a state of the cell, the state of the cell comprising values of the variables associated with the executable code in the cell and the result.

20. The system of claim 19, wherein the storage medium is communicatively coupled to the network and wherein the processor accesses the storage medium via the network interface.

21. The system of claim 19, wherein the state of the cell further comprises at least portions of files accessed in the cell.

22. The system of claim 19, wherein the server further comprises instructions that, when executed by the processor, cause the processor to generate a unique address for the cell, including its state.

23. The system of claim 19, wherein the server further comprises instructions that, when executed by the processor, cause the processor to generate a microservice based on the cell by exposing an input of the cell and an output of the cell to users of the microservice.

24. The system of claim 23, wherein the server further comprises instructions that, when executed by the processor, cause the processor to expose the input of the cell and the output of the cell by generating an application programming interface providing access to the input of the cell and the output of the cell.
